(19) United States
(12) Patent Application Publication
(10) Pub. No.: US 2020/0080904 A1
(43) Pub. Date: Mar. 12, 2020

(54) VARIABLE LOAD DYNO SYSTEM

(71) Applicant: Jose M. Mendez Mendez, Chapel Hill, NC (US)

(72) Inventor: JOSE M. MENDEZ MENDEZ, Chapel Hill, NC (US)

(21) Appl. No.: 16/558,436

(22) Filed: Sep. 3, 2019

Related U.S. Application Data
(60) Provisional application No. 62/727,688, filed on Sep. 6, 2018.

(51) Int. Cl. G01L 3/22; G01M 15/02

(52) U.S. Cl. CPC G01L 3/22; G01M 15/02

(57) ABSTRACT

A variable load dynamometer (VLD) measures the performance and operating characteristics of a test motor without the use of flywheels to supply the fixed resistance to the test motor. The VLD uses a slave motor coupled to the test motor. Using a software-controlled computer interface, the user can vary the load on the slave motor allowing for evaluation of the test motor under various load conditions. The VLD enables the user to analyze the operating characteristics and performance of the test motor by adjusting the speed of the test motor and the load applied to the test motor by the slave motor. Use of the slave motor coupled to the test motor eliminates the need for flywheels. The VLD's modular and compact design permits the evaluation of small-scale motors.

### CROSS-REFERENCE TO RELATED APPLICATIONS

This application claims the benefit of U.S. Provisional Application No. 62/727,688 filed on Sep. 6, 2018, which is hereby incorporated in its entirety.

### FIELD OF THE INVENTION

The present invention is directed to a variable load dynamometer system that can be used to analyze the performance and operating characteristics of electric motors. More specifically, the invention relates to a dynamometer system that measures various characteristics of a small-scale motor by applying variable loads to the test engine without the use of flywheels to generate inertia.

### BACKGROUND OF THE INVENTION

The following description is not an admission that any of the information provided herein is prior art or relevant to the present invention, or that any publication specifically or implicitly referenced is prior art. Any publications cited in this description are incorporated by reference herein. Where a definition or use of a term in an incorporated reference is inconsistent or contrary to the definition of that term provided herein, the definition of that term provided herein applies and the definition of that term in the reference does not apply.

Dynamometers are used to measure force, moment of force (torque), speed or power. For example, the torque produced by an engine, motor or other rotating system can be calculated simultaneously by measuring power and rotational speed (rpm). In order to properly perform the required measurements, conventional (inertia or load absorber) dynamometers are used for the measurement and analysis of engines or large motors. Inertia dynamometers are generally used in industrial applications and require flywheels to provide the load (resistance) required to measure output power and torque of the test motor, engine or other rotating system. Due to the size and weight of the flywheels required, many of the available dynamometers are large and too costly for testing small scale motors or engines. A common application for use of a dynamometer is in the design phase when various sizes and types of motors need to be evaluated. A compact design would have a broad range of applications including home appliances, toys, medical devices, test labs, and any other use involving small scale motors.

Therefore, there exists a need for a cost-effective dynamometer that can be used for small scale motor testing that does not require the use of a flywheel to provide the inertia needed for the measurements.

### SUMMARY OF THE INVENTION

The present invention is directed to a variable load dynamometer (VLD) that is used to analyze small scale electric motors without the use of flywheels to generate inertia. The VLD uses a variable load control device that adjusts the load on a slave motor that is coupled to the test motor. By varying the load (resistance) of the slave motor, the performance and operating characteristics (e.g. torque, power, efficiency) of the test motor are determined. The slave motor is fixed to a frame by two brackets with bearings that allow the slave motor shaft to rotate. The slave motor shaft is coupled to the shaft of the test motor. The test motor is fixed by a custom motor holder to the same frame as the slave motor. The position of the test motor is adjustable. The rotation of the slave motor creates an alternating current (AC) that is converted to direct current (DC) by a variable load control device. The variable load control device is connected to a dynamo control device that monitors the load on the slave motor via the load cell and is able to adjust the load based on user inputs by employing a software-controlled computer or mobile device.

All of the components are removably affixed to a frame. The dynamo control device interfaces with either a computer or a Bluetooth and mobile device combination to capture and display the generated data (performance and operating characteristics of the test motor).

In one embodiment, a variable load dynamometer is adapted to test small scale electric motors. In an embodiment, the variable load dynamometer comprises an electric test motor configured to be coupled to a slave motor, a throttle and motor controller configured to control the rotational speed of the test motor. In still another embodiment, the variable load dynamometer further comprises a load cell configured to measure the load on the slave motor, a variable load control device configured to vary the load on the slave motor, a dynamo control device configured to monitor the load on the slave motor, and a test motor sensor device configured so that the dynamo control device can monitor the performance and operating characteristics of the test motor.

In another embodiment, the variable load dynamometer comprises a test motor coupled to a slave motor. In an embodiment, the dynamo control device is connected to a variable load control device, load cell, and test motor.

In still another embodiment, a user controls the speed of the test motor and monitors and records the operating performance of the test motor by varying the load on the test motor using a software-controlled computer or mobile device.

In yet another embodiment, the variable load dynamometer comprises an inverter with an array of diodes and capacitors connected to the slave motor and to load and no-load MOSFET switches within the variable load control device. In an embodiment, the variable load control device is connected to and controlled by the dynamo control device. In a further embodiment, the variable load control device converts the alternating current (AC) of the slave motor to direct current (DC).

In one embodiment, the variable load dynamometer comprises a load cell configured to measure the load on the slave motor using a mechanical linkage comprising a pivot arm and a joint arm connected from the slave motor to the load cell. In a further embodiment, the dynamo control device is connected to and monitors the deflection of the load cell. In an embodiment, the dynamo control device is connected to the variable load control device. In yet another embodiment, the dynamo control device is connected to the test motor sensor device and monitors performance and operating characteristics of the test motor.

In still another embodiment, a variable load dynamometer is adapted to test small scale electric motors. In an embodiment, the variable load dynamometer comprises an electric test motor configured to be coupled to a slave motor, a throttle and motor controller configured to control the rotational speed of the test motor. In yet another embodiment, the variable load dynamometer further comprises a load cell configured to measure the load on the slave motor, a variable load control device configured to vary the load on the slave motor, a dynamo control device configured to monitor the load on the slave motor, and a test motor sensor device configured so that the dynamo control device can monitor the performance and operating characteristics of the test motor. In another embodiment, the test motor is coupled to the slave motor. In yet another embodiment, the dynamo control device is connected to a variable load control device, load cell, and test motor.

In one embodiment, a variable load dynamometer comprises an inverter with an array of diodes and capacitors connected to the slave motor and to load and no-load MOSFET switches within the variable load control device. In another embodiment, the variable load control device is connected to and controlled by the dynamo control device. In yet another embodiment, the variable load control device converts the alternating current (AC) of the slave motor to direct current (DC).

In still another embodiment, a user controls the speed of the test motor and monitors and records the operating performance on the test motor by varying the load on the test motor using a software-controlled computer or mobile device.

In one embodiment, a variable load dynamometer comprises a load cell configured to measure the load on the slave motor using a mechanical linkage comprising a pivot arm and a joint arm connected from the slave motor to the load cell. In another embodiment, the dynamo control device is connected to and monitors the deflection of the load cell. In yet another embodiment, the dynamo control device is connected to the variable load control device. In still another embodiment, the dynamo control device is connected to the test motor sensor device and monitors performance.

In an embodiment, the variable load dynamometer is adapted to test small scale electric motors. In another embodiment, the variable load dynamometer comprises an electric test motor configured to be coupled to a slave motor, a throttle and motor controller configured to control the rotational speed of the test motor. In still another embodiment, the variable load dynamometer further comprises a load cell configured to measure the load on the slave motor, a variable load control device configured to vary the load on the slave motor, a dynamo control device configured to monitor the load on the slave motor, and a test motor sensor device configured so that the dynamo control device can monitor the performance and operating characteristics of the test motor. In another embodiment, an inverter configured with an array of diodes and capacitors is connected to the slave motor and to load and no-load MOSFET switches within the variable load control device. In still another embodiment, the variable load control device converts the alternating current (AC) of the slave motor to direct current (DC). In yet another embodiment, the variable load control device is connected to and controlled by the dynamo control device. In an embodiment, the load cell is configured to measure the load on the slave motor using a mechanical linkage comprising a pivot arm and a joint arm connected from the slave motor to the load cell.

In one embodiment, a user controls the speed of the test motor and monitors and records the operating performance on the test motor by varying the load on the test motor using a software-controlled computer or mobile device.

Various objects, features, aspects and advantages of the inventive subject matter will become more apparent from the following detailed description of exemplary embodiments, along with the accompanying figures in which like numerals represent like components.

### BRIEF DESCRIPTION OF THE DRAWINGS

FIG. 1 is a diagrammatic illustration of a system for analyzing small scale electric motors using a variable load dynamometer (VLD).

FIG. 2 is a diagrammatic illustration of the variable load control device.

FIG. 3 is a diagrammatic illustration of the inverter contained within the variable load control device.

FIG. 4 is a diagrammatic illustration of the relationship between the inverter and the dynamo control device in a no-load state.

FIG. 5 is a diagrammatic illustration of the relationship between the inverter and the dynamo control device in a load state.

FIG. 6 is an exemplary configuration of the VLD which depicts an oblique top view of the design containing all of the labelled components.

FIG. 7 is an exemplary configuration of a portion of the VLD. The portion shown is a side-view centered on the test motor, slave motor, and coupling.

FIG. 8 is an exemplary configuration of a portion of the VLD. The portion shown is a side-view centered on the test motor, slave motor, and belt and pulley connection.

FIG. 9 is an exemplary configuration of a portion of the VLD. The portion shown is a side-view centered on the test motor, slave motor, coupling and control boards (variable load control device and dynamo control device).

FIG. 10 is an exemplary configuration of a portion of the VLD. The portion shown is an end-view of the slave motor holder, slave motor, pivot arm, joint arm, load cell, and control boards.

### DETAILED DESCRIPTION

The present invention is directed to a variable load dynamometer (VLD) that is used to analyze small scale electric motors without the use of flywheels to generate inertia or load brakes. The VLD uses an interchangeable electric direct current (DC) slave motor with computer-controlled software to vary the load and analyze the performance of the test motor. The test motor can be directly coupled or gear-reduced to the slave motor. The variable load is generated by the size and type of slave motor used and its angular speed as controlled by the user, thereby replacing the function of the flywheel. One specific advantage of the VLD is that it can precisely and quickly adjust the load on the test motor ranging from zero to full load. This allows the user to regulate and analyze the test motor at various speeds. Moreover, the user has the ability to change slave motors to increase or decrease the maximum load. Additionally, the VLD allows the user to easily change the test motor so that a variety of motors may be tested. This allows the user to expand the range of different size motors to be tested and the load applied to those motors.

As used herein, and unless the context dictates otherwise, the term “dyno” and “dynamo” are intended to represent “dynamometer” and the terms are used interchangeably. As used in the description herein and throughout the claims that follow, the meaning of “a,” “an,” and “the” includes plural reference unless the context clearly dictates otherwise. Also, as used in the description herein, the meaning of “in” includes “into” and “on” unless the context clearly dictates otherwise.

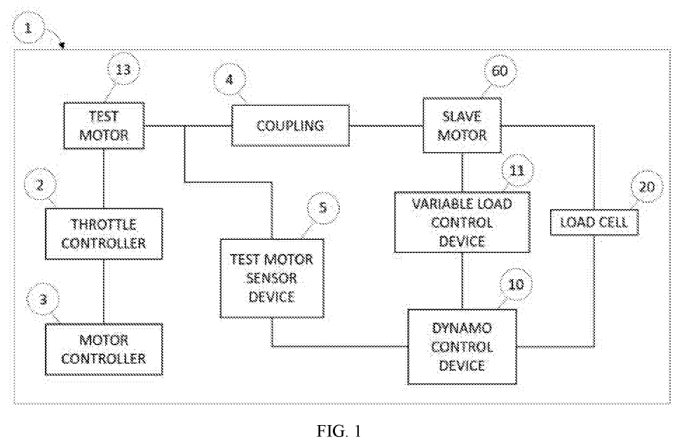

FIG. 1 is a block diagram of VLD 1 depicting the various systems comprising VLD 1. In one embodiment, test motor 13 is connected to slave motor 60 by coupling 4. The rotational speed of test motor 13 is controlled by motor controller 3 and throttle controller 2. Dynamo control device 10 measures and controls the load on slave motor 60 using load cell 20 and variable load control device 11. Dynamo control device 10 measures the operating characteristics of test motor 13 through test motor sensor device 5.

The dynamo control device 10 is connected to and controlled by a computer or mobile device with VLD 1 software. As controlled by the software, the computer or mobile device displays for the user the mechanical and electrical operating characteristics of test motor 13. The software controls VLD 1 and runs programmable test sequences in a manner best suited to the overall accuracy and efficiency of VLD 1. The data collected by dynamo control device 10 is received by the software and can be stored, displayed and printed in tabular or graphic formats. In an exemplary embodiment, test motor 13 characteristics that are measured and displayed by VLD 1 software include revolutions per minute (RPM), voltage, current, torque, power, efficiency, and milliampere-hours (mAh). The software can simulate loads, cycling the unit under test and motor ramping. Tests can be programmed to run on their own and saved for future use.

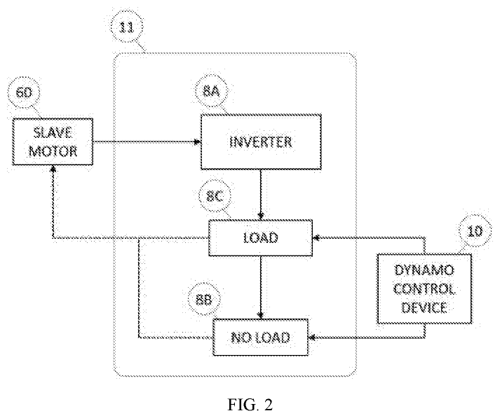

FIG. 2 is a block diagram of a variable load control device 11 and its connection to slave motor 60 and dynamo control device 10. In an embodiment, within variable load control device 11, an alternating current (AC) electrical output from slave motor 60 is converted to a direct current (DC) electrical signal by inverter 8A. In an exemplary embodiment, the DC output from inverter 8A and dynamo control device 10 control load switch 8C and no-load switch 8B thereby creating a variable load on slave motor 60.

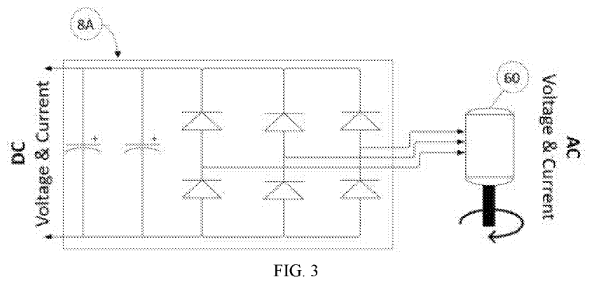

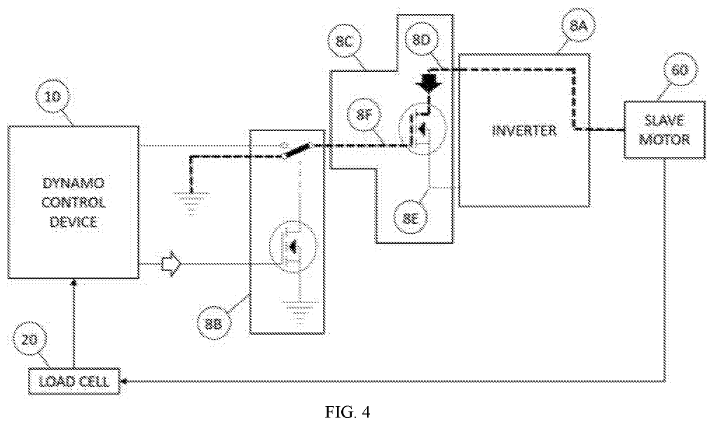

FIG. 3 is a block diagram depicting inverter 8A which is enclosed within variable load control device 11. As slave motor 60 rotates as a result of being coupled to test motor 13, slave motor 60 generates AC voltage and current. Inverter 8A comprises an array of diodes and capacitors that converts the AC voltage from slave motor 60 to DC voltage. The DC voltage level is determined by the rotational speed of slave motor 60. A higher rotational speed of slave motor 60 results in a higher DC voltage. Conversely, a lower rotational speed of slave motor 60 results in lower DC voltage output from inverter 8A. Inverter 8A output is electrically connected to a metal-oxide semiconductor field effect transistor (MOSFET) 8C as depicted in FIG. 4.

FIG. 4 is a block diagram depicting inverter 8A, no-load switch 8B, MOSFET 8C, dynamo control device 10, load cell 20, and slave motor 60. In an embodiment, MOSFET 8C comprises three main components: gate 8F, drain 8D, and source 8E. In one embodiment, drain 8D and source 8E are connected to inverter 8A, and gate 8F is located between inverter 8A and no-load switch 8B. In one embodiment, to generate a no-load state in slave motor 60, the relay within no-load switch 8B is energized by dynamo control device 10 thereby removing the power and the signal to MOSFET 8C. This allows the slave motor 60 to rotate freely without any load applied to the test motor 13.

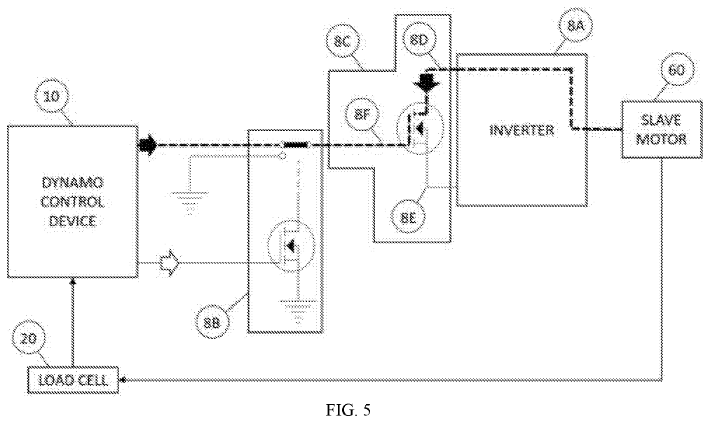

FIG. 5 is a block diagram depicting inverter 8A, no-load switch 8B, MOSFET 8C, dynamo control device 10, load cell 20, and slave motor 60. In an exemplary embodiment, MOSFET 8C is configured to function as a variable resistor (electrical load) if gate 8F and drain 8D are shorted (i.e., have DC voltage between 8F and 8D), thereby producing a voltage drop that results in a signal resistance at source 8E.

In one embodiment, to generate a load state in slave motor 60, the relay within no-load switch 8B is turned off by dynamo control device 10 allowing dynamo control device 10 to output a DC voltage to gate 8F. In an embodiment, inverter 8A also outputs a DC voltage to drain 8D, producing a voltage drop that results in a signal resistance that limits the current of gate 8F. When source 8E has a limiting current, inverter 8A restricts converted DC current passing through inverter 8A and applies a resistance (i.e., electrical load) to slave motor 60. In an embodiment, slave motor 60 transforms the electrical load to mechanical load and dynamo control device 10 reads the load cell 20 deflection. In one embodiment, the electrical load limits the angular speed of slave motor 60 thereby decreasing the speed of test motor 13.

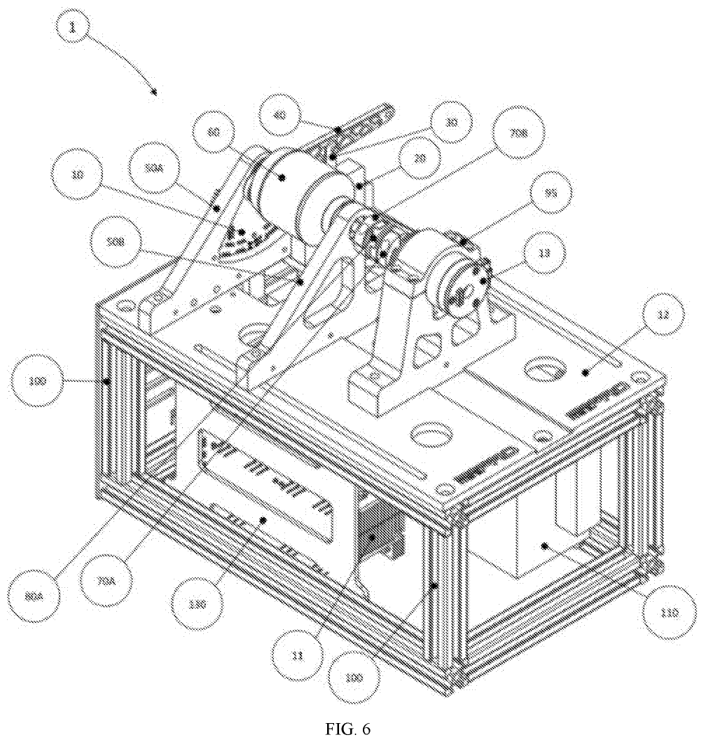

FIG. 6 depicts an exemplary configurations of VLD 1 comprising components dynamo control device 10, variable load control device 11, load cell 20, joint arm 30, pivot arm 40, rear slave motor holder 50A, front motor holder 50B, slave motor 60, test motor coupling 70A, slave motor coupling 70B, coupling disk 80A, test motor holder 95, test motor 13, upper base 12, frame 100, power supply 110, and load board holder 130. The components of VLD 1 are removably affixed to upper base 12 and frame 100 by traditional means known to one of ordinary skill in the art. In one embodiment, components are affixed to upper base 12 and frame 100 by nuts and bolts.

The construction of VLD 1 is modular, so the disassembly of VLD 1 components is possible for easy transportation, maintenance, repair, installation and adjustment.

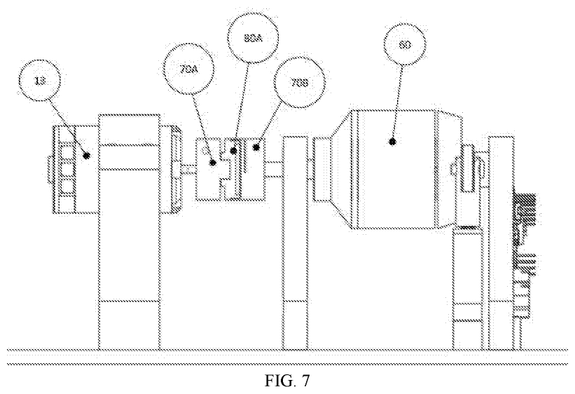

In an exemplary embodiment depicted in FIG. 7, test motor 13 and slave motor 60 are coupled using a coupling connection comprising a coupling disk 80A, test motor coupling 70A, and slave motor coupling 70B.

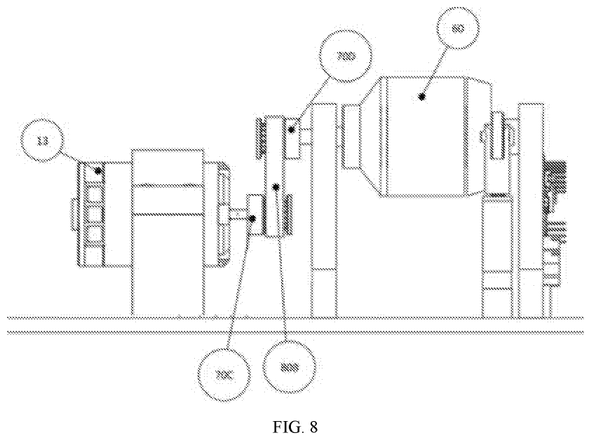

In an alternative embodiment depicted in FIG. 8, test motor 13 and slave motor 60 are coupled using a belt and pulley coupling comprising test motor pulley 70C, slave motor pulley 70D, and belt 80B.

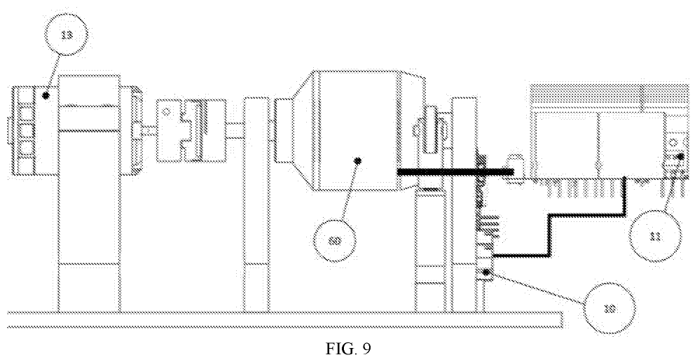

The exemplary embodiment depicted in FIG. 9 shows dynamo control device 10 and variable load control device 11. In one embodiment, as test motor 13 rotates, slave motor 60 will also rotate as test motor 13 and slave motor 60 are connected by either couplings as shown in FIG. 7 or by belts and pulleys as shown in FIG. 8. In this embodiment, the speed of test motor 13 is controlled by the user. In an exemplary embodiment, test motor 13 is powered by the user's power source (i.e., 12-volt battery connected to test motor 13).

In one embodiment, as slave motor 60 rotates, it generates an AC voltage transmitted to variable load control device 11. Dynamo control device 10 monitors and adjusts the load on slave motor 60 through variable load control device 11.

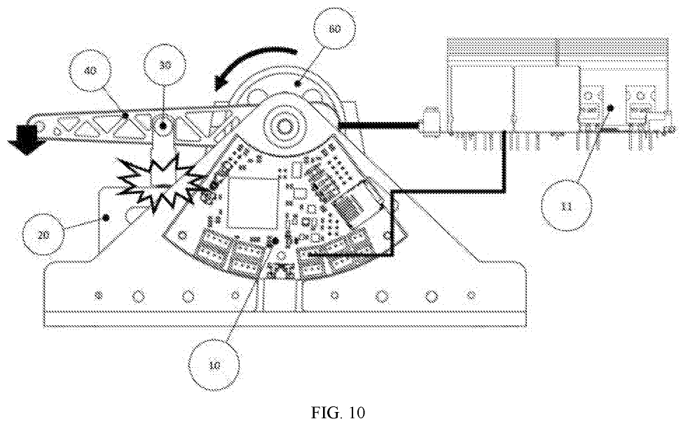

The exemplary embodiment depicted in FIG. 10 shows that as slave motor 60 rotates it creates a torque thereby forcing pivot arm 40 down, pushing joint arm 30 into load cell 20. In this embodiment, the deflection of load cell 20 is monitored by dynamo control device 10 thereby measuring the force produced by slave motor 60.

Thus, specific embodiments of VLD 1 have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced

1. A variable load dynamometer adapted to test small scale electric motors, the variable load dynamometer comprising:
a. an electric test motor configured to be coupled to a slave motor;
b. a throttle and motor controller configured to control the rotational speed of said test motor;
c. a load cell configured to measure the load on said slave motor;
d. a variable load control device configured to vary the load on said slave motor;
e. a dynamo control device configured to monitor the load on said slave motor; and
f. a test motor sensor device configured so that said dynamo control device can monitor the performance and operating characteristics of said test motor.

2. The variable load dynamometer according to claim 1, wherein:
a. said test motor is coupled to said slave motor; and
b. said dynamo control device is connected to said variable load control device, said load cell, and said test motor.

3. The variable load dynamometer according to claim 1, wherein a user controls the speed of said test motor and monitors and records the operating performance on said test motor by varying the load on said test motor using a software-controlled computer or mobile device.

4. The variable load dynamometer according to claim 1, further comprising:
a. an inverter comprising an array of diodes and capacitors connected to said slave motor and to load and no-load MOSFET switches within said variable load control device; and
b. said variable load control device is connected to and controlled by said dynamo control device;
wherein said variable load control device converts the alternating current (AC) of said slave motor to direct current (DC).

5. The variable load dynamometer according to claim 1, wherein:
a. said load cell is configured to measure the load on said slave motor using a mechanical linkage comprising a pivot arm and a joint arm connected from said slave motor to said load cell;
b. said dynamo control device is connected to and monitors the deflection of said load cell;
c. said dynamo control device is connected to said variable load control device; and
d. said dynamo control device is connected to the test motor sensor device and monitors performance and operating characteristics of said test motor.

6. A variable load dynamometer adapted to test small scale electric motors, the variable load dynamometer comprising:
a. an electric test motor configured to be coupled to a slave motor;
b. a throttle and motor controller configured to control the rotational speed of said test motor;
c. a load cell configured to measure the load on said slave motor;
d. a variable load control device configured to vary the load on said slave motor;
e. a dynamo control device configured to monitor the load on said slave motor; and
f. a test motor sensor device configured so that said dynamo control device can monitor the performance and operating characteristics of said test motor;
wherein said test motor is coupled to said slave motor; and
wherein said dynamo control device is connected to said variable load control device, said load cell, and said test motor.

7. The variable load dynamometer according to claim 6, wherein:
a. an inverter comprising an array of diodes and capacitors connected to said slave motor and to load and no-load MOSFET switches within said variable load control device; and
b. said variable load control device is connected to and controlled by said dynamo control device;
wherein said variable load control device converts the alternating current (AC) of said slave motor to direct current (DC).

8. The variable load dynamometer according to claim 6, wherein a user controls the speed of said test motor and monitors and records the operating performance on said test motor by varying the load on said test motor using a software-controlled computer or mobile device.

9. The variable load dynamometer according to claim 6, wherein:
a. said load cell is configured to measure the load on said slave motor using a mechanical linkage comprising pivot arm and joint arm connected from said slave motor to said load cell;
b. said dynamo control device is connected to and monitors the deflection of said load cell;
c. said dynamo control device is connected to said variable load control device; and
d. said dynamo control device is connected to the test motor sensor device and monitors performance.

10. A variable load dynamometer adapted to test small scale electric motors, the variable load dynamometer comprising:
a. an electric test motor configured to be coupled to a slave motor;
b. a throttle and motor controller configured to control the rotational speed of said test motor;
c. a load cell configured to measure the load on said slave motor;
d. a variable load control device configured to vary the load on said slave motor;
e. a dynamo control device configured to monitor the load on said slave motor; and
f. a test motor sensor device configured so that said dynamo control device can monitor the performance and operating characteristics of said test motor;
wherein an inverter comprising an array of diodes and capacitors connected to said slave motor and to load and no-load MOSFET switches within said variable load control device;
wherein said variable load control device converts the alternating current (AC) of said slave motor to direct current (DC);
wherein said variable load control device is connected to and controlled by said dynamo control device; and
wherein said load cell is configured to measure the load on said slave motor using a mechanical linkage comprising a pivot arm and a joint arm connected from said slave motor to said load cell.

11. The variable load dynamometer according to claim 10, wherein a user controls the speed of said test motor and monitors and records the operating performance on said test motor by varying the load on said test motor using a software-controlled computer or mobile device.
